(19) United States
(12) Patent Application Publication
(10) Pub. No.: US 2014/0003593 A1
(43) Pub. Date: Jan. 2, 2014

(54) SYSTEM AND METHOD FOR ENHANCED TELEPHONY WITH NETWORKED COMPUTING

(71) Applicant: Attila Vadasz, Budapest (HU)

(72) Inventor: Attila Vadasz, Budapest (HU)

(73) Assignee: TCT Hungary Kft., Budapest (HU)

(21) Appl. No.: 13/997,660

(22) PCT Filed: Dec. 22, 2011
(86) PCT No.: PCT/IB2011/003270

§ 371 Date: Sep. 20, 2013

Related U.S. Application Data
(60) Provisional application No. 61/426,506, filed on Dec. 22, 2010.

(51) Int. Cl. H04M 3/436

(52) U.S. Cl. CPC H04M 3/436
USPC 379/142.06

(57) ABSTRACT

A method of displaying telephone call data having the steps of receiving a network message containing a telephone id, retrieving a network address associated with the telephone id from a database, retrieving data from the network address, and causing the data to be displayed on a visual display.

### CROSS-REFERENCE TO RELATED APPLICATIONS

The present application claims the benefit of U.S. Provisional Application No. 61/426,506, filed Dec. 22, 2010, and PCT application No. PCT/IB2011/003270, filed Dec. 22, 2011, each of which are hereby incorporated by reference in their entirety.

### BACKGROUND OF THE INVENTION

The technical field relates to methods and systems which combine telephony with network linked computing.

### BRIEF SUMMARY OF THE INVENTION

The described system and method for enhanced telephony associates the event-generated signals of two independent communication channels: Internet and telephony, both having their own standards, channels and signaling methods, and based on an event in either one, triggers an event in the other.

The described system and method establishes an Internet based signaling link between two (or more) data endpoints (each defined by a client software) parallel to and associated with a telecommunication signaling link between two (or more) telecommunication endpoints (each defined by a telephone device). By this association, an event initiated by an endpoint in one channel triggers an event in an endpoint in the other channel.

In one aspect a method of displaying telephone call data is provided comprising the steps of: receiving a network message containing a telephone id; retrieving a network address associated with said telephone id from a database; retrieving data from the network address; causing the data to be displayed on a visual display. The method may further comprise the step of providing a signaling server for sending the network message. The signaling server may be connected to a telecommunication operator main switch.

In another aspect, the method may further comprising the step of providing an aggregator server connected to the network for containing said database. The method may further comprise the steps of: connecting to an advertising server; receiving advertising data from the advertising server; displaying the advertising data on the visual display.

### BRIEF DESCRIPTION OF THE DRAWINGS

FIG. 1 is a block diagram of a first embodiment system for enhanced telephony with networked computing.

FIG. 2 is a screen shot one of the visual displays of the system shown in FIG. 1.

### DETAILED DESCRIPTION OF THE INVENTION

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Telecommunication carried out on PSTN networks faces significant limitations when used to transfer visual information between the parties during a phone call. Some of these limitations are mainly due to the physical barriers of the handheld devices often used. For example small screens can present only limited information, the screen on handheld devices usually are not visible during a call, and searching for relevant information is limited on a handheld device during a call.

When a telephone call is posted, often there is another device available and visible to the caller, such as a big screen device with Internet connection. This device can be an Internet connected computer or an Internet connected television/set-top box capable of running custom client software.

Disclosed embodiments provide a system to make use of a big screen device with a network connection to provide an additional communication channel to enhance a telephone call. More specifically, in order to make use of the larger display on the big screen device to show information relevant to the telephone conversation, a client software is provided and installed on the big screen device. The client software defines the big screen device as an online data endpoint and is uniquely linked to the telephone endpoint by a logical link between the client software and the telephone number.

Disclosed embodiments generally provide a method of causing a telephone call placed in a PSTN network to trigger client software on a party's big screen device to display customized information about the other party.

Disclosed embodiment systems carry out the above mentioned event flow by following the general steps of:
a.) capturing the signal information about a call in progress including: a first telephone number (caller's number), a second telephone number (dialed number), and the event type (call initiated, call ended, transferred, on hold, etc.)
b.) transferring the captured signal information it to the data endpoints (big screen devices) associated with each these numbers; and
c.) trigger the client applications on the data endpoints to collect and display information as specified according to a given endpoint's profile.

According to its desired operation, the system and method generally consists of a three layered structure including:
1. a provider server (custom signaling server) which captures the call information from the PSTN operator's main switch via standard protocols, and transfers it to the client application associated to the telephone numbers taking part in the call;
2. an aggregator server which stores profile information associated with each data endpoint (client application) including:
   a. data intended to be shared with other users, and
   b. data expected to be displayed about other users; and
3. a client application which collects local and on-line information about the other party according to its profile, and displays it on the large display.

The provider server (custom signaling server) receives and handles all the relevant signaling information about a call in the system. Signaling information captured includes the caller number (first number), the dialed number (second number), and the call event type (including the event types of call initiated, call ended, transferred, on hold, etc.)

Receiving the call event information from the main switch is done via interfaces using standard telecommunication protocols (SS7, NAP, etc.). The use of the appropriate protocol is defined by the technology running the telecom operators main switch.

Based on the received information, the signaling server makes a lookup on the aggregator server for caller related information and transfers the found results and the lookup information to the client application(s). The client application displays the caller information received from the signaling server and makes further searches using the received information (lookup in local contacts, social networks, etc.)

Client applications are logged into the signaling server to create a definitive matching between a telephone endpoint and a data endpoint: every phone number has to have at least one client application associated to it; and every client application needs to have at least one phone number associated to it.

The client-server registration procedure is handled via a secured channel, ensuring that no one can register to his/her data endpoint with a telephone number other than his/her number. A channel of this type can be either an IVR system or a messaging server, both of which are capable of receiving caller ID information, or any other similar method of fulfilling the above mentioned criteria. During registration a system generated password is paired to the respective phone number. Password information is stored on the signaling server for later client login.

The aggregator server contains the profile information of each client application. Profile information may include: phone numbers, e-mail addresses, marketing related information (age, gender, profession) optionally to service the advertising network's needs, IDs for various social network sites (Facebook, Twitter, LinkedIn, etc.), static location communicated by the client, or ID-s for various dynamic location services (Google Latitude, Facebook Places, Foursquare, Gowalla, etc.), IDs for on-line e-mail services (passwords for these stored only locally in an encrypted format), video information opt-in, and/or any other information (on-line or off-line) that a user wishes to share (for example web pages, images of public webcams, location based weather info, etc.). Along with providing this information, a user declaration is required stating that he/she is opting in to allow other users to see the pages and information associated to these identities.

The aggregator server also contains information about what type of data the user wishes to see about the other parties (e.g. if a user wants to see other's Facebook page, but not their Twitter feed). The aggregator server is also connected to various advertising networks (Google Adsense, Gemius, Adverticum, etc.), and based the user's stored marketing profile instructs the client applications through the signaling server to download and display targeted marketing material from these networks. At every call event this profile is matched in both direction to the parties, and the client applications are instructed to display the relevant data for the parties.

The client software, after the initial registration, logs in to the provider server using the login information stored in the client and automatically sent to the aggregator server.

After login the client application runs in the background, and is in online connection with the server side of the System. If an event is registered by the signaling server concerning one of the registered phone numbers, the following steps are taken by the client software associated to this phone number:
1. the profile of the other number is displayed on screen
2. according to the profile match, the relevant external network data (webpages) are displayed
3. according to the profile match the relevant e-mail messages in either a local or online email database are searched and displayed (mail from on-line e-mail services such as Gmail or Hotmail after a secure login to these)
4. according to the video opt-in, if both parties clients are active, the video stream of the other party is displayed
5. according to the location opt-in, the other party's location is displayed on a map
6. according to the user's marketing profile, the targeted marketing material is displayed in the banner windows

At the end of the call, the signaling server receives the “Call End” message from the operator's main switch, which instructs the client applications to close the information windows being displayed.

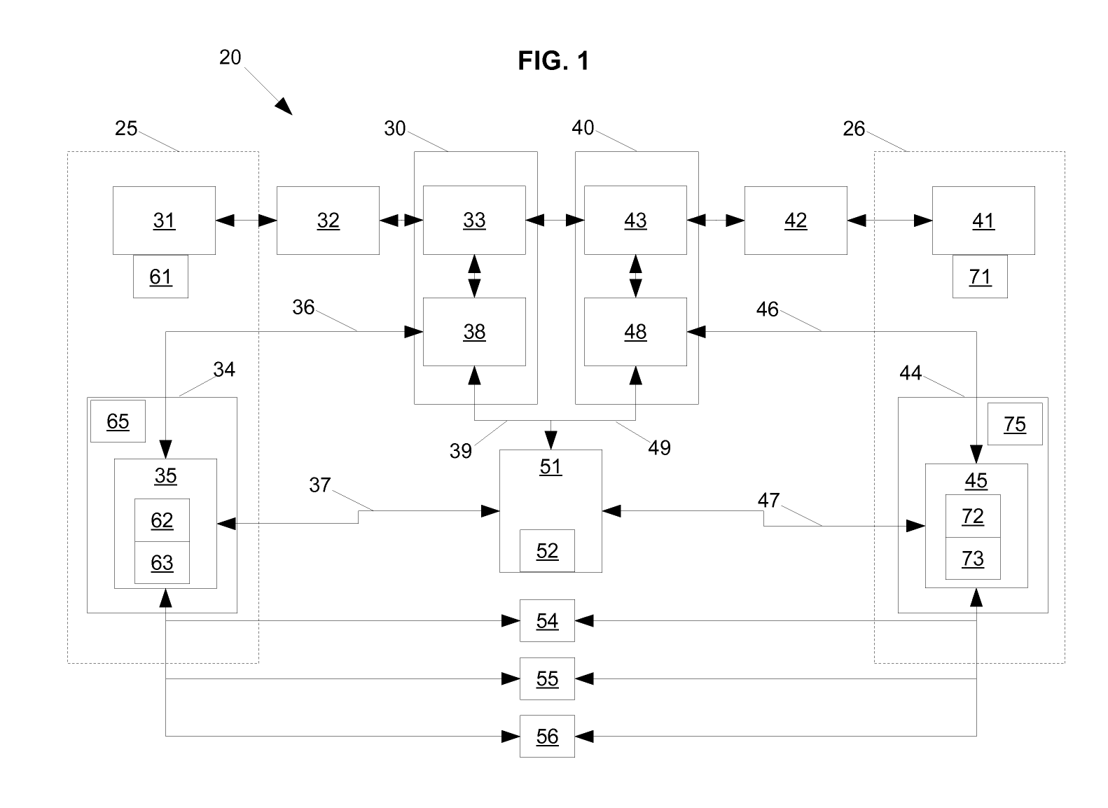

Referring now to the drawings, and more particularly FIG. 1, a first embodiment system and method for enhanced telephony with networked computing is generally indicated at 20. System 20 broadly provides an enhanced telecommunication link between first user location 25 and a second user location 26.

As shown in FIG. 1, system 25 more specifically comprises: first user location 25, first PSTN network 32, first telecommunication operator location 30, second telecommunication operator 40, second PSTN network 42, and second user location 26. System 20 also includes aggregator server 51, and several Internet links between system 20 elements and third party network services 54, 55, and 56.

First user location 25 and second user location 26 typically contain identical subcomponents. First user location 25 comprises first telephone 31, and first user computer 34. First telephone 31 is a standard land line telephone or a cellular telephone, and has unique phone number 61. First telephone 31 links to first PSTN network 32. First PSTN network 32 is a standard PSTN network connected to first telecommunication operator 30.

First telecommunication operator 30 has at least one main switch 33. Main switch 33 typically includes a service switching point for handling event notifications about incoming and outgoing calls as well as control decisions. Also installed at telecommunication operator physical location 30 is first provider server 38. First provider server 38 communicates with main switch 33's switching point through a variety of different protocols such as SS7, INAP, etc., to relay signaling event information. The signaling event information includes the caller number, dialed number, and the call event type (such as call initiated, ended, transferred, on hold, etc.). A link between first telecommunication operator 30 and second telecommunication operator 40 is made, linking main switch 33 to second telecom operator main switch 43 to provide the call signaling and data channels. First provider server 38 contains Internet connection 36 to first user computer 34 for providing call event information and receiving first user status information. First provider server 38 also uses its Internet connection for linking with aggregator server 51. Aggregator server 51 is typically located at a separate physical location from first user location 25, first telecommunication operator 30, and second telecommunication operator 40.

Similar to first telecommunication operator 30, second telecommunication operator 40 has main switch 43 which also typically includes a service switching point for handling event notifications about incoming and outgoing calls as well as control decisions. Similarly installed at telecommunication operator physical location 40 is second provider server 38. Second provider server 48 communicates with main switch 43's switching point to relay signaling event information. The exact hardware and communication protocols used by second telecommunication operator 40 may be different than those used by first telecommunication operator 30 since the provider servers 38, 48 are capable of handling multiple protocols.

Second provider server 48 also contains Internet connection 46 to second user computer 44 for providing call event information and receiving second user status information. Second provider server 48 also uses its Internet connection for linking with aggregator server 51. Aggregator server 51 uses its links to first provider server 38 and second provider server 48 in order to synchronize event information.

Referring back to second operator main switch 43, a link is made from main switch 43 to second PSTN network 42. Second PSTN network 42 is connected to second user telephone 41, which has telephone number 71. Similar to first user physical location 25, second user physical location contains both second telephone 41 and second user computer 44.

On each user computer 34, 44, are client software instances 35 and 45 respectively, and visual displays 65, and 75 respectively. Client software 35 contains unique identification ID 62 and client software instance 45 contains a different identification ID 72. Both instances of client software, 35, and 45, also contain respective local profile databases, 63, and 73, which will be discussed in more detail in the following sections. A primary function of client software 35 and 45 is controlling information displayed on visual displays 65, 75. Client software 35, 45 form secure Internet connections with aggregator server 51 and third party network services 54, 55, 56. For example third party network server 54 may be a social networking site such as Facebook, network service 55 may be a geographic mapping service such as Google Maps, and network service 56 might be an email service such as a Microsoft Outlook Server. Additionally, one of the network service providers may be an advertising server.

Aggregator server 51 contains profile database 52 which stores client software ID records linked to telephone numbers. Each record may also contain: an account username, password, alternate phone numbers, email addresses, marketing related information (age, gender, profession), IDs and login information for various social network sites (such as Facebook, Twitter, LinkedIn, etc.), static location information, IDs for various dynamic location services (Google Latitude, Facebook Places, Foursquare, Gowalla, etc.), IDs for on-line e-mail services (passwords for these stored only locally in an encrypted format), video information opt-in, and any other information (online or offline) that a user wishes to share (such as web page, images of public web-cams, location based weather info, etc.). The profile information in database 52 is the same type of data which may be stored in local profile database 63 and 73. First and second user computers 34, 35 may also contain a video capture device (66, 76) such as a webcam.

The elements shown in FIG. 1 together form a system and method to provide first and second users enhanced information on displays 65 and 75 when a phone call is made between first telephone 31 and second telephone 41. The operation of system 20 prior to and during a phone call initiated from first telephone 31 to second telephone 41 will be described in the following.

Before a phone call is even placed, the first and second user clients need to be registered. More specifically, the first user needs to initialize client software 35 by providing phone number 61 and receiving or choosing a unique client software ID 62. For example, client software ID may be a first username with an associated first password. Client software 35 makes a secure connection with aggregator server 51. During registration, a database entry is made in database 52 for phone number 61 and software client id 61. Similarly, a database entry is made for registration of second user with phone number 71 and software client id 72. When a first user is ready to user the enhanced telephony system, first client software 35 is activated, causing it to make a secure network connection to aggregator server 51. First client software also makes a secure network connection to first provider server 38.

Similarly, second user activates second client software 45, causing secure network connections to be formed with both aggregator server 51 and second provider server 38. When client software 35 is connected to aggregator server 51, when first connected, and at a first specified time period thereafter, local profile database 63 is updated with contents from aggregator server database 52.

First user dials telephone number 71 on first telephone 31. First telephone 31 sends a message to first PSTN network 32, which is received by first telecom operator 30. More specifically, first telecom operator main switch 33 receives the signal that phone number 61 is calling phone number 71. The service switching point in main switch 33 forwards an event to both second telecom operator's main switch 43 as well as first provider server 38.

When first user is ready to call second user, second telephone phone number 71 is dialed into first telephone 31. A signal/message containing the calling phone number and the dialed phone number is sent from first telephone 31 to first PSTN network 32, and is received by first telecom operator main switch 33. Main switch 33 generates sends event signals to both first provider server 38 and second telecom operator main switch 43. First provider server sends a message with the dialed number over secure network connection 36 to first client software. Client software 35 receives the message containing second telephone number 71, and the corresponding local profile database 63 record is identified. The identified database record provides network addresses for third party network services 54, 55, and 56. Client software 35 then accesses these third party network locations to obtain data associated with second telephone number 71. For example, the user for second telephone number 71 may have provided his Facebook webpage address in his profile. This profile information was provided from the aggregator server 51 to first instance client software 35. When client software 35 receives the message that phone number 71 is being called, it finds the Facebook webpage address from local profile database 63, and accesses the webpage address directly from Facebook at network service 54. The Facebook page data is then displayed on visual display 65. Similarly, the location data identified in second user's profile is accessed from network service 55 and also displayed on visual display 65. This data display can all occur prior to when second telephone 41 is answered.

As mentioned earlier, main switch 33 forwards the phone call request message to main switch 43. Main switch 43 forwards this message to both second PSTN network 42 and second provider server 48. Second provider server sends a message over secure network connection 46 to second instance client software 45, indicating to client software 45 that first phone number 61 is trying to call second user. Client software 45 then similarly looks in its local profile database 73 for the record that is associated with phone number 61. The third party network locations 54, 55, 56 are accessed and their data is displayed on visual display 75.

In the meantime, second PSTN network forwards the call request message to second telephone 41. At this point, the first user is able to view enhanced data about the second user on visual display 65, and the second user is able to view enhanced data about the first user on visual display 75, before the call is even answered.

When the phone call is answered, a similar message is relayed from second telephone 41 back through all elements of system 20. Upon receiving a phone call is connected message, client software 35 and client software 45 may activate a video chat link between first user computer 34 and second user computer 44.

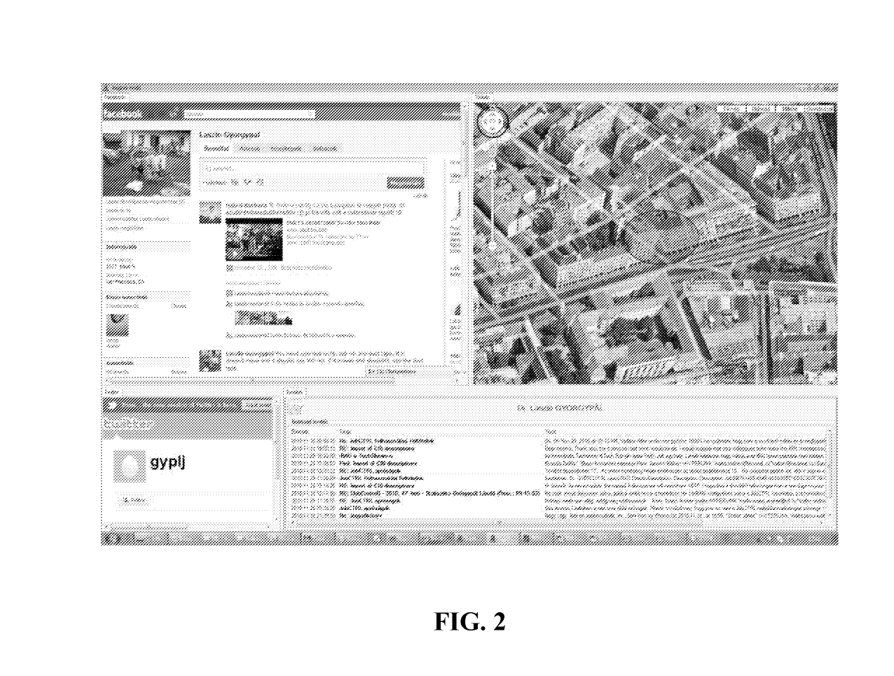

FIG. 2 is a screenshot of the visual display frame produced by client software 35. A first pane provides a Facebook webpage, a second pane a map of a parties location, a third pane a Twitter webpage, and a final pane for a listing of relevant emails. Additional data panes may be for live video, chat, or other similar feeds. Additional panes may be organized in a tabbed format.

The system resulted in a number of surprising and useful results. Communication between private individuals is significantly enhanced to provide a more efficient and enjoyable telecommunication experience. Communications between an individual and a company can take place to provide data exchanges that are not possible over a telephone line only. This system and method results in benefits for both the customer and company in terms of service level, time efficiency, and satisfaction level.

Additionally, a possible way to cover the operation costs of the system can be the sales of targeted advertising space within the client application. This space can be utilized by: a. the telephone network operator in return for allowing the System's signaling server to be installed on its premises, and providing the necessary call signal information, or b. various other advertising networks and ad server services on a per view, per click or other settlement basis.

Therefore, while the presently-preferred form of the system and method for enhanced telephony with networked computers has been shown and described, and several modifications thereof discussed, persons skilled in this art will readily appreciate that various additional changes may be made without departing from the spirit of the invention, as defined and differentiated by the following claims.

1. A method of displaying data associated with a telephone call comprising the steps of:
receiving a network message containing a telephone id;
retrieving a network address associated with said telephone id from a database;
retrieving a data from said network address; and
causing said data to be displayed on a visual display.

2. The method of claim 1, and further comprising the step of providing a signaling server for sending said network message.

3. The method of claim 2, wherein said signaling server is connected to a telecommunication operator main switch.

4. The method of claim 3, and further comprising the step of providing an aggregator server connected to a network for containing said database.

5. The method of claim 5 and further comprising the steps of:
connecting to an advertising server;
receiving advertising data from said advertising server; and
displaying said advertising data on said visual display.

6. The method of claim 1, and further comprising the step of providing a client software application configured and arranged to run on a first user computer.

7. The method of claim 6, and further comprising the step of providing a telephone number to said client software application associated with a first user.

8. The method of claim 1, wherein said data is a data from an email server, a social networking server, a dynamic location service, a webcam, a weather information service, or a user profile.

9. The method of claim 8, wherein said user profile comprises a name, an email address, a picture, a job description, or a location.

10. The method of claim 4, and further comprising the step of registering a user phone number associated with a client application with said aggregator server.

11. The method of claim 2, wherein said signaling server is configured and arranged to use SS7, or INAP protocols.

12. A method of enhanced telephony telecommunication comprising the steps of:
providing a client software to run on a first data endpoint computer connected to a network, said first data endpoint computer having a display;
providing said client software to run on a second data endpoint computer connected to a network, said second data endpoint computer having a display;
associating a first telephone number to said first data endpoint computer client software;
associating a second telephone number to said second data endpoint computer client software;
providing a aggregator server having a database for storing associations between said first and second telephone number and said first and second data endpoint computer client software;
providing a signaling server for receiving call events from a PSTN network associated with said first telephone number;
receiving a phone call start event from a device with said first telephone number on said signaling server, said start event including a destination phone number;
sending said call start event to said aggregator server;
sending a network message to a data endpoint computer associated with said destination phone number;
causing said data endpoint computer associated with said destination phone number to display data associated with said first telephone number.

13. The method of claim 12, wherein said data associated with said first telephone number is a data from an email server, a social networking server, a dynamic location service, a webcam, a weather information service, or a user profile.

14. The method of claim 13, wherein said user profile comprises a name, an email address, a picture, a job description, or a location.

15. The method of claim 12, and further comprising the step of storing user profile data associated with a telephone number on a database on said aggregator server.

16. The method of claim 12, wherein said signaling server is configured and arranged to use SS7, or INAP protocols.

17. The method of claim 12, wherein said data associated with said first telephone number is obtained from a third party system.

18. The method of claim 12, and further comprising the step of displaying data from an advertising server on one of said data endpoint computers.

19. The method of claim 12, and further comprising the step of encrypting data transferred between said first data endpoint computer and another computer.

20. The method of claim 12, and further comprising the step of causing said aggregator server to automatically gather information from a third party source specified in a user profile.
